(19) United States
(12) Patent Application Publication
(10) Pub. No.: US 2006/0241977 A1
(43) Pub. Date: Oct. 26, 2006

(54) Patient medical data graphical presentation system

(76) Inventors: Loretta A. Fitzgerald, Collegeville, PA (US); Lisa T. O'Neill, West Chester, PA (US)

Correspondence Address: Siemens Corporation;Intellectual Property Department, 170 Wood Avenue South, Iselin, NJ, 08830, US

(21) Appl. No.: 11/231,226

(22) Filed: Sep. 20, 2005

Related U.S. Application Data
(60) Provisional application No. 60/674,272, filed on Apr. 22, 2005.

(51) Int. Cl. G06F 19/00

(52) U.S. Cl. 705/3

(57) ABSTRACT

A system provides a comprehensive overview of patient health problems and treatments over an extended period of time in a graphical representation of diagnostic procedures, sites of disease and interventions. A user interface system for presenting patient medical information, includes at least one medical data repository including medical data identifying treatments previously received by a patient. A display processor initiates generation of data representing a graphical image of at least a portion of human anatomy. The graphical image includes multiple data items identifying the treatments previously received by the patient and corresponding user selectable links to associated treatment medical information in the at least one medical data repository. A command processor commands the display processor to initiate generation of data representing an image including additional information concerning a particular treatment in response to user selection of a link corresponding to the particular treatment identified by a particular data item of the multiple data items.

This is a non-provisional application of provisional application Ser. No. 60/674,272 by L. A. Fitzgerald filed Apr. 22, 2005.

### FIELD OF THE INVENTION

This invention concerns a graphical user interface system for presenting patient medical information and links to associated treatment information.

### BACKGROUND OF THE INVENTION

Medical records are currently segmented according to patient problems, diagnoses and episodes of care. Healthcare providers spend much time and effort gathering patient records and reviewing them to gain a comprehensive understanding of patient medical history as a whole. Currently Clinical Information Systems employ graphical displays presenting documentation, which may use an anatomical figure as a navigational tool to assist a user in documenting patient physical assessment data. In the existing graphical documentation systems, an anatomical figure is typically part of an assessment form itself and is limited to being linked to the data within the form. A system according to invention principles addresses this deficiency and related problems.

### SUMMARY OF INVENTION

A system provides a comprehensive overview of patient health problems and treatments over an extended period of time in a graphical representation of diagnostic procedures, sites of disease and interventions occurring over the lifetime of the patient enabling user access to pertinent patient history data. A user interface system for presenting patient medical information, includes at least one medical data repository including medical data identifying treatments previously received by a patient. A display processor initiates generation of data representing a graphical image of at least a portion of human anatomy. The graphical image includes multiple data items identifying the treatments previously received by the patient and corresponding user selectable links to associated treatment medical information in the at least one medical data repository. A command processor commands the display processor to initiate generation of data representing an image including additional information concerning a particular treatment in response to user selection of a link corresponding to the particular treatment identified by a particular data item of the multiple data items.

### BRIEF DESCRIPTION OF THE DRAWING

FIG. 1 shows a networked hospital information system including a graphical user interface system, according to invention principles.

FIG. 2 shows a graphical user interface providing a comprehensive overview of patient health problems and treatments over an extended period of time including links to access treatment information, according to invention principles.

FIG. 3 shows a system employed by a graphical user interface, according to invention principles.

FIG. 4 shows a flowchart of a process for providing a graphical user interface, according to invention principles.

### DETAILED DESCRIPTION OF THE INVENTION

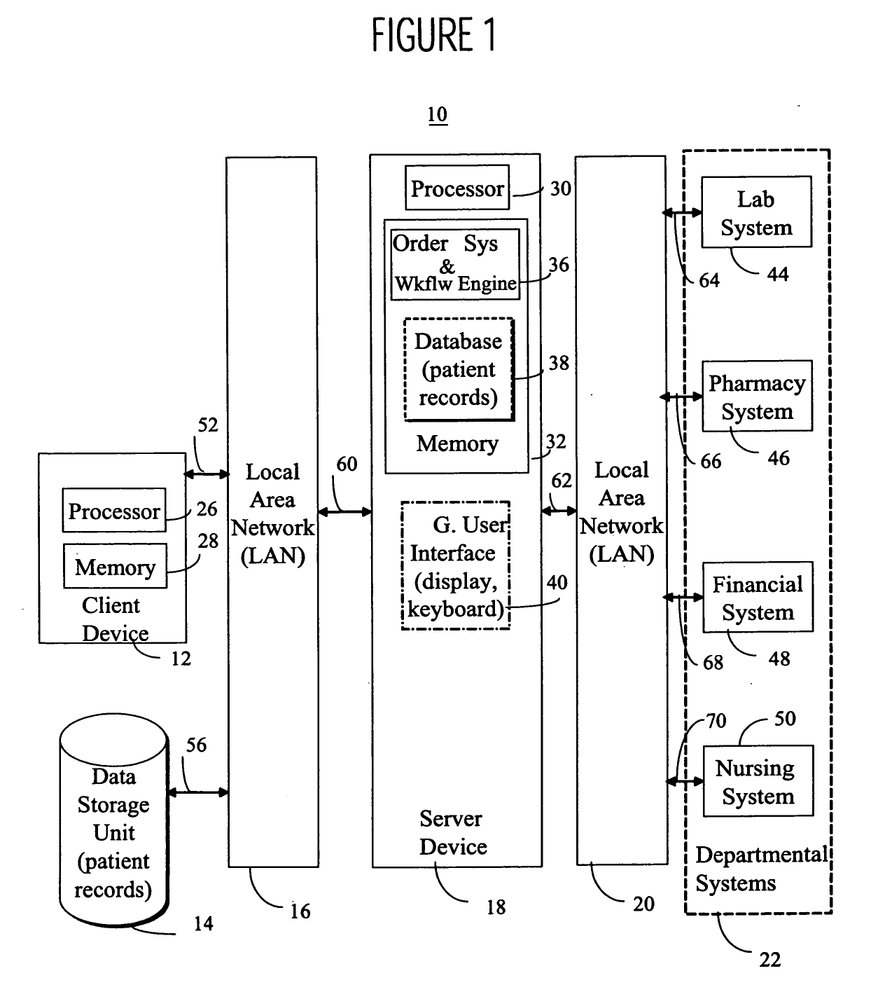

FIG. 1 shows a networked hospital information system including a graphical user interface system. The graphical user interface system provides a comprehensive overview and record of patient health problems and treatments over an extended period of time such as a month, year, or a patient lifetime, for example. The overview comprises a graphical representation of diagnostic procedures, sites of disease and interventions occurring over the lifetime of the patient enabling user access to pertinent patient history data. In contrast, existing graphical medical data representations show areas of a patient body that have corresponding data documented within a form that is typically limited to a single encounter with the patient. In contrast the system provides a global overview of patient health problems and treatments over an extended period of time and multiple encounters. An encounter as used herein comprises a patient encounter with a healthcare enterprise involving patient and healthcare enterprise interaction that has a financial or transaction consequence and may include for example a patient visit, phone call, inpatient stay or outpatient treatment etc.

The graphical user interface provides a graphical image of at least a portion of human anatomy giving a user at a glance, a substantially immediate overview of patient health history, as well as single click access to associated treatment data in the form of reports and images. Thereby the graphical user interface system provides a user with necessary information to facilitate patient care in a fraction of the time a user would spend navigating through a patient medical record to access the information. Further, the graphical user interface provides a comprehensive overview and record of patient health problems and treatments over a patient lifetime which advantageously improves patient safety by ensuring a user accesses a complete patient medical history potentially affecting a current condition of a patient. Also the user interface graphical presentation uses an anatomical representation that advantageously facilitates and accelerates user assessment of a patient medical history.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device and associated data acquisition and processing functions.

FIG. 1 shows a networked hospital information system 10 employing a graphical user interface system 40 providing a comprehensive overview of patient health problems. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

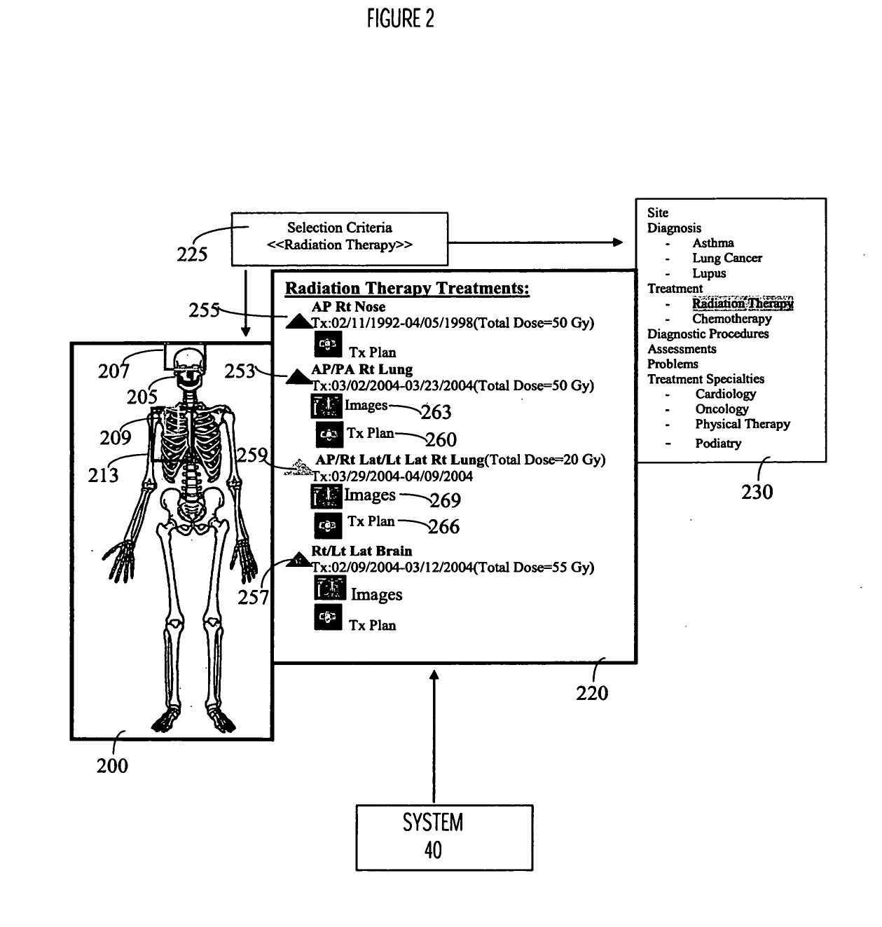

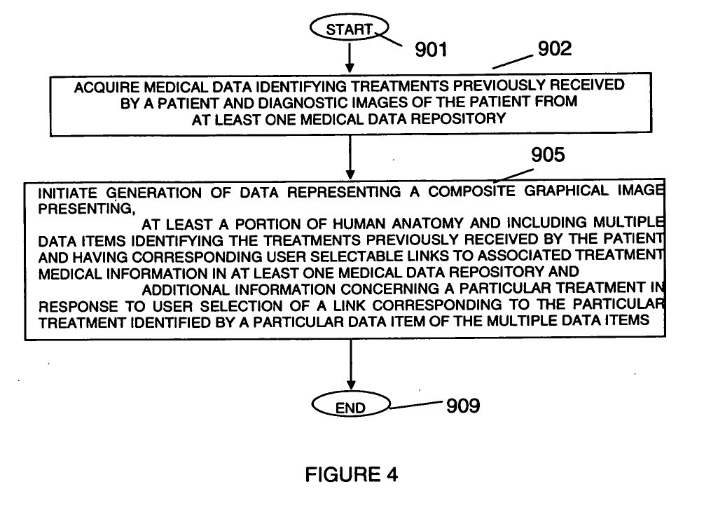

User interface system 40 displays a patient record in a graphical representation which visually provides the user with an overview of the treatments a patient has received as shown in FIG. 2 and supports the process of FIG. 4. User interface system 40 (which may also reside in client device 12) includes an input device that permits a user to perform data and command entry and input information and an output device that provides a user a display of a graphical representation comprising an overview of the treatments administered to a patient. Preferably, the input device is a keyboard and mouse, but also may be a touch screen or a microphone with a voice recognition program, or a telephone voice response system for example. The output device is a display, but also may be a speaker, for example. The output device provides information to the user responsive to the input device receiving information from the user or responsive to other activity by client device 12. For example, a display presents information responsive to the user entering information via a keyboard.

Server device 18 includes graphical user interface system 40, processor 30, a memory unit 32 including treatment order system and workflow engine 36 and a database 38 containing patient records including medical data identifying treatments previously received by a patient. Unit 36 also includes a patient assessment data acquisition and processing application and a clinical data management system. Graphical user interface system 40 provides the graphical representation of FIG. 2 comprising a comprehensive overview of patient health problems and treatments over an extended period of time including links to access treatment information. Graphical user interface system 40 initiates generation of data representing a graphical image presenting a human anatomy (or at least a portion of human anatomy) in image window 200. The graphical image in image window 200 incorporates multiple data items identifying treatments previously received by a patient and together with corresponding user selectable links to associated treatment medical information in database 38. Specifically, image window 200 shows data items identifying four anatomical areas 205, 207, 209 and 213 having associated treatments previously received by a patient. Areas 205, 207, 209 and 213 are indicated by rectangles overlaying an anatomical area previously treated. The rectangular areas are user selectable links to associated treatment medical information in database 38. In other embodiments, areas and user selectable links may be designated by at least one of, text, shading, lines, highlighting, one or more different colors, hypertext links or different shapes or symbols.

Graphical user interface system 40 initiates generation of data representing a graphical image including additional information in image window 220 concerning one or more particular treatments in response to user selection of a link in window 200 corresponding to the particular treatment identified by a particular data item (rectangles) of the multiple data items. Specifically, in response to user selection of rectangle 205 (and associated link) radiation treatment therapy information 255 is displayed in image window 220 and upon user selection of rectangle 207 (and associated link) radiation treatment therapy information 257 is displayed in image window 220. Further, in response to user selection of rectangle 209 (and associated link) radiation treatment therapy information 259 is displayed in image window 220 and upon user selection of rectangle 213 (and associated link) radiation treatment therapy information 253 is displayed in image window 220. Thereby a user is able to access detailed treatment information including documentation and images which may be also displayed in window 220. Alternatively, additional links may be included in window 220 enabling a user to navigate to additional documentation or images.

The FIG. 2 composite image and associated user interface organizes data indicating patient health problems and treatments and provides an advantageous visual representation that is particularly helpful for patients that are receiving radiation therapy treatments, and have metastases or recurrence, for example. Human tissue is able to safely receive a limited cumulative lifetime dose of radiation during sessions of radiation therapy. In addition, radiation beam overlap needs to be avoided to prevent an overlap of radiation fields potentially causing the administration of a radiation overdose to a patient. The FIG. 2 composite graphical image includes image window 200 presenting a portion (or entire) human anatomy that provides a visual representation of the treatment areas together with image window 220 presenting detailed information of the treatments themselves, in response to user image element selection (in window 200). Thereby via image window 200, a user is made aware of previous and proposed treatment fields and their proximity. A user is also able to access detailed treatment information in image window 220 through area (and associated link, e.g., hypertext link) selection in image window 200. The accessed detailed treatment information supports clinical decision making and aids prevention of administration of a radiation overdose to a patient. A user is also able to access patient anatomical images in window 220 (via link selection in window 200 or window 220) enabling a user to view treated areas. In addition, window 220 provides treatment dose and cumulative dose information enabling a user to make treatment decisions and to determine whether a patient is a candidate for radiation. Such a decision may be made, for example, if it is determined a particular patient anatomical area, following receipt of the proposed radiation treatment, receives less than a threshold maximum lifetime cumulative value of radiation or conversely would receive a radiation dose in excess of threshold maximum lifetime cumulative value of radiation. In contrast, existing systems may require a user to employ documentation such as a hand drawn diagram to make such a decision.

Radiation Oncology treatment is dependent upon anatomical images to assess efficacy (or otherwise) of administered treatments. It is desirable to provide a user with the ability to view such images in different ways. Graphical user interface system 40 advantageously enables a user to configure a display image such as an image incorporating image windows 200 and 220 of FIG. 2 to comprise a single image window with the detailed treatment information in window 220 overlaying appropriate corresponding rectangles in the anatomical image of window 200. In this image configuration, the detailed treatment information is incorporated in window 200 in response to user selection of one or more corresponding rectangles in window 200, for example.

Graphical user interface system 40 also advantageously enables a user to configure a display image to incorporate images indicating the relationship of treatment fields to one another and also to include associated diagnostic images. In the FIG. 2 image, for example, a user is able to select treatment plans and diagnostic images via selection of icons 260 and 263 respectively of the treatment delivered to the AP/PA Rt Lung 255 of window 220. The treatment plans and images are displayed in a single composite image together with windows 200 and 220 or, in another configuration, in one or more different images. Similarly, a user is able to select treatment plans and images via selection of icons 266 and 269 respectively of the treatment delivered to the AP/Rt Lat/Lt Lat Rt Lung Treatments of window 220. In a further example, treatment plans are displayed in a single composite image together with a diagnostic CT image that was taken of the L-Spine, for example. In other image configurations, the treatment plans and diagnostic CT image are displayed in one or more different images together with (or without in another configuration) windows 200 and 220. The provision of a single composite image combining treatment information and diagnostic images advantageously enables a user to see a treated anatomical location and to determine whether proximity to another treatment area may create an overdose problem. Graphical user interface system 40 also provides an image enabling a user to view three dimensional anatomical images from a user selectable angle and to determine whether proximity of a proposed treatment region to another treatment region in three dimensions may create an overdose problem.

The displayed images provided by user interface 40 provide an overview of patient health problems and treatments over an extended period of time (e.g., a patient lifetime). Graphical user interface 40, in providing an image presenting clinical information associated with an anatomical treatment region, enables a user to better assess and evaluate cumulative effects of therapies (e.g., radiation, chemotherapy, drugs etc.) and provides a visual lifetime record of therapies and diagnostics performed on a patient. The visual representation of data also provides additional quality assurance for a user by identifying potential risk to a patient. For example, a patient who has received prior radiation therapy to a pelvic area returns 8 years later with bone metastasis to the right hip and is being assessed as a candidate for radiation therapy to this area. A user employing the FIG. 2 image is able to visually gauge the proximity of a previously treated area to a candidate treatment area of concern and is able to easily access a previous treatment record. This enables the user to assess if the patient received a lifetime maximum dose of radiation to the area in question and is able to safely receive further radiation treatment to this area. In another embodiment, the graphical depiction of the body or body part is adapted to meet the needs of a specialty of the user, (i.e. a podiatrist office uses diagrams of the feet, a cardiologist office uses diagrams of the heart etc.).

Graphical user interface 40 also provides image elements and menus enabling a user to configure a display image (such as the FIG. 2 image). The image elements and menus are accessed and displayed within a browser type toolbar, for example. Specifically, configuration menu 225 enables a user to select particular criteria (e.g., a type of therapy) in configuring the FIG. 2 anatomical display image window 200 and associated selected treatment information image window 220. A user employs configuration menu 225 to selects a type of therapy from types such as, radiation, chemotherapy, physical and drug therapy. The type of therapy selected via menu 225 is used by interface 40 to determine the treatment areas displayed (e.g., identified rectangular areas 205-213 for the selected radiation therapy type) in the graphical image presenting a human anatomy (or at least a portion of human anatomy) in image window 200. Other different identified areas are displayed for corresponding types of selected therapy in the human anatomy image in window 200.

A user employs configuration menu 230 to select categories of information to be displayed in image window 220 concerning a type of therapy selected via menu 225. The categories of information that may be configured to be displayed in image window 220 determine treatment information displayed in response to user selection in window 200 of an anatomical area such an identified rectangular area 205, 207, 209 or 213 for radiation therapy. A user configures window 220 to present detailed treatment information concerning category items such as anatomical site, diagnosis, treatment, diagnostic procedures, patient assessment by a physician, problems and treatment specialties including, cardiology, oncology, physical therapy and podiatry, for example.

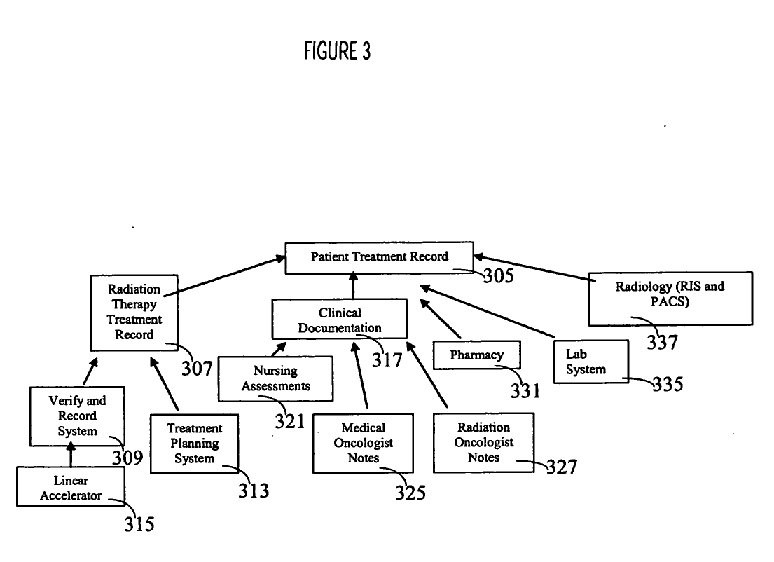

FIG. 3 shows a system employed by graphical user interface 40 for displaying a graphical representation comprising a comprehensive overview of patient health problems and treatments over an extended period of time. The comprehensive patient health overview incorporates treatment information acquired from patient treatment record 305 in response to user selection of links in window 200 (FIG. 2). Patient treatment record 305 comprises treatment information derived by system 40 from multiple different sources. These sources include, for example, a radiation therapy treatment record 307, clinical documentation 317 maintained in a Hospital Information System (HIS), a pharmacy information system 331, a laboratory information system 335, and a radiology information system (RIS) and Picture Archiving and Communication System (PACS) 337. The radiation therapy treatment record 307 includes treatment related information acquired from linear accelerator (or other treatment modality device) 315 via record and verification system 309 as well as from treatment planning system 313. Clinical documentation 317 includes nursing assessment information 321, medical oncology notes 325 and radiation oncology notes 327.

Returning to the FIG. 1 system, server device 18 may be implemented as a personal computer or a workstation. Database 38 provides a location for storing patient treatment record 305 (FIG. 3) and other patient records and data storage unit 14 provides an alternate store for patient records, as well as other information in hospital information system 10. The information in data storage unit 14 and database 38 is accessed by multiple users from multiple client devices. User interface 40 provides a comprehensive patient health overview incorporating treatment information acquired from patient treatment record 305 in response to user selection of links in window 200 (FIG. 2). Patient treatment record 305 comprises treatment information derived by system 40 that may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

The first local area network (LAN) 16 (FIG. 1) provides a communication network among the client device 12, the data storage unit 14 and the server device 18. The second local area network (LAN) 20 provides a communication network between the server device 18 and the departmental systems 22. Departmental systems 22 include laboratory system 44, a pharmacy system 46, a financial system 48 and a nursing system 50 and may also include various treatment modality systems (including radiation, RIS-PACS, ultrasound, light systems etc.), a records system, a patient administration system, an accounting system, a billing system, and any other system required or desired in a healthcare information system. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

FIG. 4 shows a flowchart of a process performed by graphical user interface 40 (FIG. 1). In step 902 following the start at step 901, user interface 40 acquires medical data identifying treatments previously received by a patient and medical data identifying diagnostic images from at least one medical data repository. In step 905, user interface 40 initiates generation of data representing a graphical image presenting at least a portion of human anatomy including multiple data items identifying the treatments previously received by the patient and corresponding user selectable links to associated treatment medical information in the at least one medical data repository. The corresponding user selectable links are links to associated treatment medical information concerning treatment received by the patient over the entire lifetime of the patient (or an extended period), comprising at least one of, (a) therapies, (b) diagnostic studies, (c) images, (d) medications and (e) assessments. The treatments previously received by the patient comprise treatments received over an extended period such as over years or a lifetime of the patient. A data item identifies at least one of, (a) a cumulative radiation dose received by a particular anatomical portion of the patient in a radiation therapy treatment, (b) a cumulative chemotherapy dose and (c) a cumulative medication dose, received by a particular anatomical portion of said patient. Further, the at least a portion of human anatomy is a particular anatomical portion of the patient or the whole anatomy.

User interface 40 initiates generation of data representing an image window including additional information (such as a treatment plan or diagnostic image) concerning a particular treatment in response to user selection of a link corresponding to the particular treatment identified by a particular data item of the multiple data items. In one configuration, user interface 40 initiates generation of data representing a graphical (or composite) image incorporating the at least a portion of human anatomy and the image window including the additional information concerning a particular treatment in a single image window. In other configurations the graphical image presents the at least a portion of human anatomy and the image window including the additional information concerning a particular treatment in at least one of, (a) multiple different image windows in an image and (b) multiple different images. The composite image may include a diagnostic image of the patient derived from the at least one medical data repository, for example.

The graphical image indicates an area or volume of the at least a portion of the human anatomy affected by a treatment previously received by the patient, as well as treatment dosage variation in the affected area or volume of the at least a portion of the human anatomy. The area or volume of the at least a portion of the human anatomy affected by the treatment previously received by the patient, is derived based on at least one of, (a) cumulative treatment dosage and (b) information identifying an orientation of an axis of treatment application in relation to said anatomy. Further, the graphical image presents the at least a portion of the human anatomy in at least one of, (a) a manipulable 2 dimensional representation and (b) a manipulable three dimensional representation, manipulable by at least one of, (i) rotation and (ii) zoom functions, in response to user command. Also the graphical image of the at least a portion of human anatomy identifies an orientation of an axis of treatment application in relation to the anatomy. The process of FIG. 4 terminates at step 909.

The system, user interface images and processes presented in FIGS. 1-4 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems of FIGS. 1 and 3 and process of FIG. 4 may be implemented in hardware, software or a combination of both. The user interface system is advantageously applicable to data processing involving capturing data over a period of time and requiring that the captured data be revisited in order to make decisions for current situations. For example, a home builder may document when work was performed by a roofer, plumber, and electrician. In the future if the homeowner would like additional electrical work performed, the builder has access to the original documentation and can easily see how to tap into existing wiring for the extension. The system may provide a global overview of the builder's progress in a development, by providing a visual indication of the plumbers as they are installing in multiple homes. If the plumbers indicate their progress, the builder would be able to easily see the progress and know which homes are complete or have not been started.

What is claimed is:

1. A user interface system for presenting patient medical information, comprising:
at least one medical data repository including medical data identifying treatments previously received by a patient;
a display processor for initiating generation of data representing a graphical image presenting at least a portion of human anatomy, said graphical image including a plurality of data items identifying said treatments previously received by said patient and corresponding user selectable links to associated treatment medical information in said at least one medical data repository; and
a command processor for commanding said display processor to initiate generation of data representing an image window including additional information concerning a particular treatment in response to user selection of a link corresponding to said particular treatment identified by a particular data item of said plurality of data items.

2. A system according to claim 1, wherein
a data item identifies a cumulative radiation dose received by a particular anatomical portion of said patient in a radiation therapy treatment.

3. A system according to claim 1, wherein
a data item identifies at least one of, (a) a cumulative chemotherapy dose and (b) a cumulative medication dose, received by a particular anatomical portion of said patient.

4. A system according to claim 1, wherein
said at least a portion of human anatomy is a particular anatomical portion of said patient.

5. A system according to claim 1, wherein
said treatments previously received by said patient and identified by said data items, comprise treatments received over a lifetime of said patient.

6. A system according to claim 1, wherein
said graphical image indicates an area or volume of said at least a portion of said human anatomy affected by a treatment previously received by said patient.

7. A system according to claim 6, wherein
said graphical image indicates treatment dosage variation in said affected area or volume of said at least a portion of said human anatomy.

8. A system according to claim 6, wherein
said graphical image presents said at least a portion of said human anatomy in at least one of, (a) a manipulable 2 dimensional representation and (b) a manipulable three dimensional representation, manipulable by at least one of, (i) rotation and (ii) zoom functions, in response to user command.

9. A system according to claim 6, wherein
said area or volume of said at least a portion of said human anatomy affected by said treatment previously received by said patient, is derived based on at least one of, (a) cumulative treatment dosage and (b) information identifying an orientation of an axis of treatment application in relation to said anatomy.

10. A system according to claim 1, wherein
said at least a portion of said human anatomy comprises the whole anatomy.

11. A system according to claim 1, wherein
said corresponding user selectable links are links to associated treatment medical information concerning treatment received by said patient over the entire lifetime of said patient, comprising at least one of, (a) therapies, (b) diagnostic studies, (c) images, (d) medications and (e) assessments.

12. A system according to claim 1, wherein
said graphical image of said at least a portion of human anatomy identifies an orientation of an axis of treatment application in relation to said anatomy.

13. A system according to claim 1, wherein
said graphical image incorporates said at least a portion of human anatomy and said image window including said additional information concerning a particular treatment in a single image window.

14. A system according to claim 1, wherein
said graphical image presents said at least a portion of human anatomy and said image window including said additional information concerning a particular treatment in at least one of, (a) a plurality of different image windows in an image and (b) a plurality of different images.

15. A method for providing a user interface presenting patient medical information, comprising the activities of:
acquiring medical data identifying treatments previously received by a patient from at least one medical data repository;
initiating generation of data representing a graphical image presenting at least a portion of human anatomy, said graphical image including a plurality of data items identifying said treatments previously received by said patient and corresponding user selectable links to associated treatment medical information in said at least one medical data repository; and
commanding said display processor to initiate generation of data representing an image including additional information concerning a particular treatment in response to user selection of a link corresponding to said particular treatment identified by a particular data item of said plurality of data items.

16. A user interface system for presenting patient medical information, comprising:
at least one medical data repository including medical data identifying treatments previously received by a patient; and
a display processor for initiating generation of data representing a composite graphical image presenting,
at least a portion of human anatomy including a plurality of data items identifying said treatments previously received by said patient, said data items having associated corresponding user selectable links to associated treatment medical information in said at least one medical data repository and
additional information concerning a particular treatment in response to user selection of a link corresponding to said particular treatment identified by a particular data item of said plurality of data items.

17. A system according to claim 16, wherein
said at least one medical data repository includes medical data identifying diagnostic images of said patient and
said composite image includes a diagnostic image of said patient derived from said at least one medical data repository.

18. A system according to claim 16, wherein
said additional information concerning a particular treatment comprises a treatment plan.

19. A system according to claim 16, wherein
said composite graphical image presents said at least a portion of human anatomy and said additional information concerning a particular treatment in a single image window.

20. A system according to claim 16, wherein
said composite graphical image presents said at least a portion of human anatomy and said additional information concerning a particular treatment in a plurality of different image windows in said composite image.
